(19) United States
(12) Patent Application Publication
(10) Pub. No.: US 2023/0354280 A1
(43) Pub. Date: Nov. 2, 2023

(54) METHOD, DEVICE, COMPUTER PROGRAM PRODUCT, AND NON-TRANSITORY INFORMATION STORAGE MEDIUM FOR ALLOCATING RADIO FREQUENCY RESOURCE

(71) Applicant: Mitsubishi Electric Corporation, Tokyo (JP)

(72) Inventors: Jean-Christophe SIBEL, Rennes Cedex 7 (FR); Artem BORYSKIN, Rennes Cedex 7 (FR)

(73) Assignee: Mitsubishi Electric Corporation, Tokyo (JP)

(21) Appl. No.: 17/913,995

(22) PCT Filed: Mar. 12, 2021
(86) PCT No.: PCT/JP2021/011558

§ 371 Date: Sep. 23, 2022

(30) Foreign Application Priority Data
Apr. 8, 2020 (EP) 20168689.6

(51) Int. Cl. H04W 72/0453; H04W 72/52; H04W 72/541

(52) U.S. Cl. CPC H04W 72/0453; H04W 72/52; H04W 72/541

(57) ABSTRACT

The radio frequency resource is shared between the first device and at least one second device connected to a second radio access network. The first device first obtains information representative of a usage of the radio frequency resource by the second device. Then, it obtains a threshold value of a collision rate acceptable for the second device. It determines a value representative of an estimated collision rate as experienced by the second device for at least one frequency resource allocation of the first device from the obtained information representative of the usage of said radio frequency resource by said second device. Finally, the first device uses the at least one frequency resource allocation for the first device in the case where the determined value is below the obtained threshold value.

### TECHNICAL FIELD

At least one of the present embodiments generally relates to a method and a device for allocating a portion of radio frequency resource to a first device, more particularly in the case where said radio frequency resource is shared between said first device and at least one second device.

### BACKGROUND ART

In wireless communications coexistence problems occur when different systems operate by sharing the same communication resources, notably frequency resources. Indeed, some frequency bands, especially unlicensed frequency bands, may be overcrowded because of the deployment of multiple devices.

In the past few years, communications systems such as those operating in accordance with different radio access technologies (RAT) such as IEEE 802.11 (Wi-Fi) and Bluetooth have been increasingly deployed in the ISM unlicensed 2.4 GHz band (acronym of “Industrial, Scientific, and Medical”). The ISM band is a portion of the radio spectrum originally reserved internationally for industrial, scientific and medical (ISM) purposes other than telecommunications, e.g. microwave ovens, garage door openers, baby monitors. Despite the intent of the original allocations, in recent years the fastest-growing use of these bands has been for short-range, low power wireless communications systems. As more and more devices use the ISM band, the spectrum becomes more crowded, which in turns degrade the quality of service in this band.

The shared frequency range of the two IEEE 802.11 (Wi-Fi) and Bluetooth standards inevitably results in transmission interference and data corruption as the two protocols operate with transmission frequencies that overlap at various times during routine transmission of information. The resulting frequency overlap degrades the network performance and transmission rates in both families of devices due to a lack of ability of wireless devices which use differing protocols to coordinate their data transmissions. This problem is exacerbated as the number of wireless devices within the network increases and is further affected by the proximity in which the wireless devices are placed with respect to one another.

The same type of problems occur in the unlicensed ITS 5.9 Ghz band (acronym of “Intelligent Transport System”). Indeed, communications systems such as those operating in accordance with IEEE 802.11p, IEEE 802.11ac, C-V2X (acronym of “Cellular Vehicle to Everything”), CBTC (acronym of “Communications-Based Train Control”) standards have been increasingly deployed in the ITS band.

The coexistence between devices and radio access technologies (RAT) could be handled in a number of different ways using, for example, an opportunistic random access or some collision avoidance schemes.

Opportunistic random access technologies provide a way to efficiently allocate network resources, in particular, when the number of devices sharing the same radio resource is large. Classically, a device that is willing to transmit data listens to the communication medium and begins to transmit data when it detects an available transmission window. Collision risks are limited by applying a random waiting time before effectively initiating transmission. It however does not avoid that several devices may select the same radio resource, i.e. the same frequencies, at the same time for transmitting data. Opportunistic random access technologies thus provide a good spectrum use at the cost of a performance loss, i.e. a high collision rate.

Collision avoidance techniques are thus used to avoid resource contention. These techniques attempt to eliminate situations in which multiple devices access the same radio resource at the same time. They ensure that any device in a network can transmit data without colliding with other traffic on the network.

Collision management mainly appears in networks with carrier sense multiple access (CSMA). Devices that are willing to transmit data have to listen to the channel for some time to determine whether other devices are using the shared radio resource. A device can start transmission only if a channel is sensed to be idle, otherwise, transmissions are deferred. Two main approaches have been developed in CSMA: collision detection and collision avoidance. With collision detection, transmitters creating a collision stop transmitting and defer their transmission for a random time. Collision are thus not avoided and iterations of transmissions often occur. Collision avoidance is another approach that prevents multiple devices from transmitting at the same time on the same frequency resource, by implementing a dedicated protocol based on an exchange of RTS (acronym of “Request To Send”) and CTS (acronym of “Clear To Send”) messages. However, such protocol implies overhead, which degrades transmission performance.

Collision avoidance techniques thus provide a good performance, i.e. low collision rate, at the cost of a poor spectrum use.

It is thus desirable to share radio resources between devices using the same radio frequency resource, e.g. the same frequency band or channel, while maintaining both good performance and good use of the spectrum.

### SUMMARY OF INVENTION

According to a general aspect of at least one embodiment, a method for allocating a radio frequency resource to a first device connected to a first radio access network is presented. The radio frequency resource is shared between said first device and at least one second device connected to a second radio access network. The method comprises the following steps executed by the first device:
obtaining information representative of a usage of said radio frequency resource by said second device;
obtaining a threshold value of a collision rate acceptable for the second device;
determining a value representative of an estimated collision rate as experienced by the second device for at least one frequency resource allocation of the first device from the obtained information representative of the usage of said radio frequency resource by said second device;
using said at least one frequency resource allocation for the first device in the case where the determined value is below the obtained threshold value.

The method detailed herein may be deployed wherever there is coexistence in the same frequency resource, e.g. band or channel, of different devices using same RAT or different RAT.

By accepting a given collision rate defined by at least one threshold value related to the second device, the method makes it possible to better use the spectrum while maintaining good performance in terms of number of correct received packets divided by number of sent packets.

According to a specific characteristic, said information representative of a usage of said radio frequency resource by said second device comprises a frequency resource allocation pattern and a value of a time interval for collision rate estimation (e.g. frame length).

According to a specific embodiment, determining a value representative of an estimated collision rate as experienced by the second device for at least one frequency resource allocation of the first device being defined by another frequency resource allocation pattern comprises mapping said frequency resource allocation pattern and said another frequency resource allocation pattern in order to obtain overlaps in frequency resource allocation during a time interval (e.g. T) and determining the value by dividing the obtained overlaps by the overall time of usage of said radio frequency resource by said second device during said time interval, wherein said time interval (T) is defined from said time interval related to collision rate estimation (e.g. from frame length).

According to a specific embodiment, said information representative of a usage of said radio frequency resource by said second device is obtained by the first device from said second device through application layer or physical layer, by sensing or from preconfigured data.

According to a specific embodiment, determining a value representative of an estimated collision rate as experienced by the second device for at least one frequency resource allocation to the first device is determined from a database of preconfigured frequency resource allocation pattern, wherein said database associates with each possible combination of frequency resource allocation patterns an estimated collision rate for the first device and an estimated collision rate for the second device.

According to a specific embodiment, obtaining a threshold value of a collision rate acceptable for the second device comprises:
obtaining at least a first threshold value and a second threshold value of a collision rate acceptable for the second device, said first and second threshold values each being associated with a spatial zone or a level of interference signal; and
selecting said one threshold value among said first and second threshold values.

According to a specific embodiment, selecting said one threshold value among said first and second threshold values comprises:
determining a location of said first device; and
selecting the threshold value responsive to said location.

According to a specific embodiment, selecting said one threshold value among said first and second threshold values comprises:
determining a distance between said first device and said second device; and
selecting the threshold value responsive to said distance.

According to a specific embodiment, selecting said one threshold value among said first and second threshold values:
determining a level of interference signal as sensed by the first device; and
selecting the threshold value responsive to said level of interference signal.

According to a specific embodiment, said at least a first threshold value and a second threshold value of an acceptable collision rate for the second device are obtained by said first device from the network, from said second device through application or physical layer or from preconfigured data.

According to a specific embodiment, the method further comprising receiving new threshold values of a collision rate acceptable for the second device, said new threshold values being determined from the actual collision rate experienced by the second device because of the first device.

According to a specific embodiment, the method further comprises receiving new threshold values of a collision rate acceptable for the second device, said new threshold values being determined from the actual collision rate experienced by the second device because of the first device and at least a third device.

According to a specific characteristic, the first and the second radio access networks implement different radio access technologies.

According to a general aspect of at least one embodiment, a device connected to a first radio access network is presented. This said device shares a radio frequency resource with at least one second device connected to a second radio access network. The device comprises:
means for obtaining information representative of a usage of said radio frequency resource by said second device;
means for obtaining a threshold value of a collision rate acceptable for the second device;
means for determining a value representative of an estimated collision rate as experienced by the second device for at least one frequency resource allocation of the first device from the obtained information representative of the usage of said radio frequency resource by said second device;
means for using said at least one frequency resource allocation for the first device in the case where the determined value is below the obtained threshold value.

One or more embodiments also provide a computer program product including program code instructions for performing at least part of any of the methods described above. One or more of the present embodiments also provide a computer readable storage medium having stored thereon instructions for performing at least part of any of the methods described above.

### BRIEF DESCRIPTION OF DRAWINGS

The characteristics of the invention will emerge more clearly from a reading of the following description of at least one example of embodiment, said description being produced with reference to the accompanying drawings.

FIG. 1 depicts a scenario in which various embodiments may be implemented.

FIG. 2 illustrates the principles of deterministic radio frequency resource allocation between a first device and one second device that use the same radio frequency resource.

FIG. 3 illustrates the principles of deterministic radio frequency resource allocation between a first device and one second device that use the same radio frequency resource.

FIG. 4 illustrates the principles of deterministic radio frequency resource allocation between a first device and one second device that use the same radio frequency resource according to one specific embodiment.

FIG. 5 depicts a flowchart of a method for radio frequency resource allocation according to a first embodiment.

FIG. 6 depicts a database of preconfigured radio allocation patterns.

FIG. 7 depicts a flowchart of a method for radio frequency resource allocation according to a second embodiment.

FIG. 8 illustrates the principles of associating different threshold values with different spatial zones.

FIG. 9 depicts spatial zones of various foinis.

FIG. 10 depicts a flowchart of a method for radio frequency resource allocation according to a third embodiment.

FIG. 11 illustrates the principles of associating different threshold values with different levels of interference signal.

FIG. 12 illustrates schematically an example of hardware architecture of a device according to a specific embodiment.

### DESCRIPTION OF EMBODIMENTS

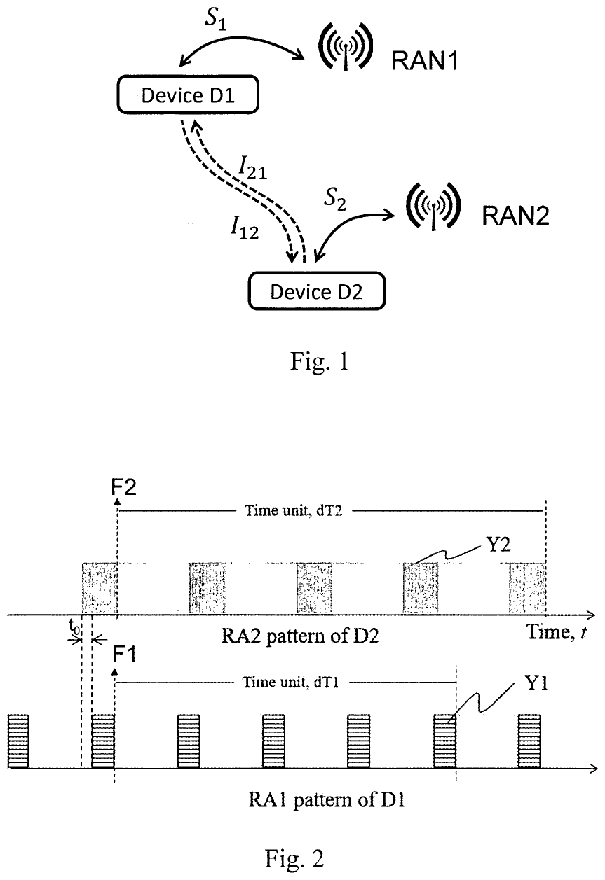

FIG. 1 depicts a scenario in which various embodiments may be implemented. Two separate devices D1 and D2 share the same radio frequency resource, e.g. the same frequency band or channel. D1 transmits and receives data using a first radio access network denoted RAN1 and D2 transmits and receives data using a second radio access network denoted RAN2. The devices D1 and D2 are for example communication terminals.

In one embodiment, RAN1 and RAN2 are identical and use one and the same radio access technology. As an example, the device D1 is located in a train, RAN1 is compliant with CBTC, the device D2 is located in another train and RAN2 is also compliant with CBTC.

In another embodiment, RAN1 and RAN2 are different and use different radio access technologies. As an example, the device D1 is located in a train, RAN1 is compliant with CBTC, the device D2 is located in a vehicle such as a car and RAN2 is compliant with C-V2X. Vis versa, the device D1 is located in a vehicle such as a car, RAN1 is compliant with C-V2X, the device D2 is located in a train and RAN2 is compliant with CBTC. The train and the car are not communication terminals per se. However, they may comprise such communication terminals D1 and D2. More generally, the devices D1 and D2 may be located in vehicles with Wi-Fi connections capabilities (i.e. conforming to IEEE 802.11), smartphones (i.e. conforming to IEEE 802.11ac), vehicles with 4G/5G capabilities (i.e. conforming to C-V2X), train (conforming to CBTC), etc.

In FIG. 1, S1 and S2 denote the average received modulated carrier power received by each device at its current location. I₁₂ represents the interference signal level as incurred by the device D2 and I₂₁ represents the interference signal level as incurred by the device D1. Thus, I₁₂ is representative of the impact of the transmissions of the device D1 on the transmissions of the device D2 and I₂₁ is representative of the impact of the transmissions of the device D2 on the transmissions of the device D1. In one embodiment, the interference signal level is understood as the signal-to-interference ratio (SIR or S/I). It is the quotient between the average received modulated carrier power S and the average received co-channel interference power, i.e. cross-talk, from other transmitters than the transmitter of the useful signal.

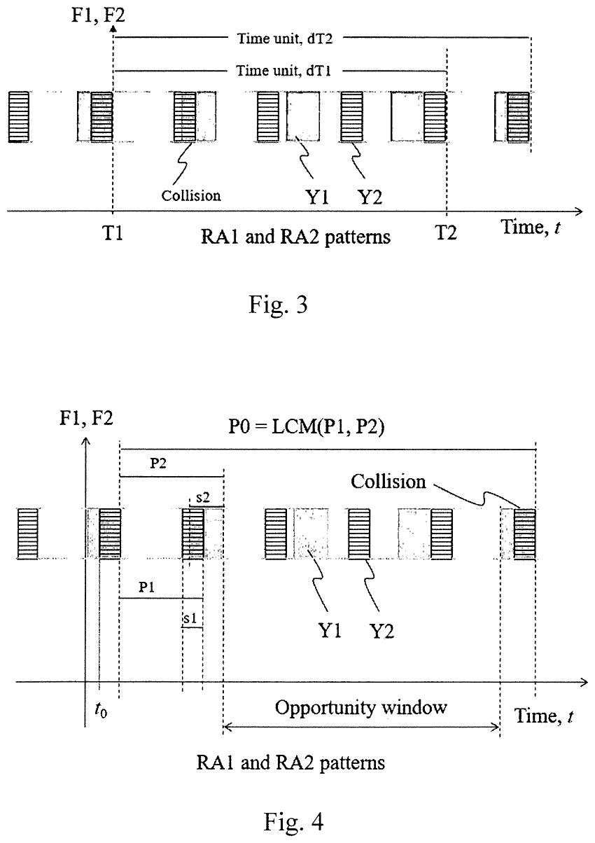

FIGS. 2 and 3 illustrate the principles of deterministic radio frequency resource allocation between a first device D1 and one second device D2 that use the same radio frequency resource (RR), e.g. the same frequency band or channel, according to one specific embodiment. The frequency resource allocation (RA) for one device is defined by a RA pattern. Thus, a RA pattern defines a particular way in which frequency resource allocation occurs for a given device. In case of deterministic frequency resource allocation, the frequency resource allocation is defined by a pattern. The RA pattern can be a deterministic pattern associated with a periodic traffic comprising a sequence of identical frames as depicted in FIGS. 2 and 3. Each RA pattern is thus defined as a periodic step function, namely F1(t) for device D1 and F2(t) for device D2. In FIGS. 2 and 3, the hatched blocks Y1 and the gray block Y2 correspond to the time intervals used for communication by D1 and D2 respectively. The gaps between grey and hatched blocks represent time intervals during which the RR remains idle.

The time intervals dT1 and dT2 related to D1 and D2 respectively, are generally defined as follows: dTi=Pi*Ki, where i is an index identifying the device (e.g. i=0 or 1), Pi is length of the frame of Di and Ki is an arbitrary integer number selected independently by each device (e.g. K1=K2=4 as depicted on FIG. 2). Indeed, on FIG. 2, the time intervals dT1 and dT2 are defined to be equal to 4 frames. However, the number of frames in the time intervals dT1 and dT2 may be different. The difference in dT1 and dT2 results into different collision rates experienced by D1 and D2. The collision rate also depends on an offset t0 which is a time offset between RA1 and RA2. For large values of Ki, the fluctuation of the collision rate with respect to the offset t0 decreases. Each device selects the time interval, thus a Ki value, voluntary to meet its own minimum requirements. As an example, the time interval for a train may be defined as the minimum amount of time to ensure critical communications such as emergency communications, e.g.to perform train emergency break, which is typically a few seconds in urban areas (depends on train speed). For vehicle safety applications, the time interval may be shorter. An estimated collision rate is defined as the average number of collisions per interval of time, dT. Assuming that any overlap in RR usage is qualified as a collision as depicted in FIG. 3, the estimated collision rate is ¼ for D1, i.e. 25%, whereas the collision rate for D2 is 2/4, i.e. 50%. The difference is explained by the length of the frame and the value of the time interval of each device.

While deteiniinistic patterns are illustrated in FIGS. 2 and 3, the embodiments also apply to a random use of radio frequency resources. In one embodiment related to random frequency resource allocation, the collision rate may be estimated based on the probability of collision between a random frequency resource allocation RA1 and any type of frequency resource allocation RA2 selected by D2, provided that it can also be interpreted in terms of an average frequency resource load. For instance, in the case where D1 usage of RR is characterized by a random frequency resource allocation with 50% channel load and D2 usage of RR is also random with 50% channel load, the estimated collision rate may be calculated as a probability of collision between the two random frequency resource allocations, which is 25% (i.e. 0.5×0.5=0.25). The same collision rate of 25% may be estimated in the case where D2 usage of RR is deterministic with a channel load of 50%.

FIG. 4 illustrates the principles of deterministic radio frequency resource allocation between a first device D1 and one second device D2 that use the same radio frequency resource (RR), according to one specific embodiment. The elements identical to the elements of FIGS. 2 and 3 are identified by the same numeral references and are not further disclosed.

P1 and P2 are the periods of the RA patterns RA1 and RA2 respectively, i.e. the lengths of the frames. t0 is a time offset between RA1 and RA2. The overlap of the two periodic step functions F1(t) and F2(t) results in beating with a beat period P0 equal to the least common multiple (LCM) of P1 and P2. As illustrated in FIG. 4, the usage of two periodic step functions may lead to the formation of an “opportunity window”. This “opportunity window” is repeated for each beat period P0. Provided that the device D2 communicates only during the duration of the “opportunity window”, no collision occurs or an acceptable level of collision rate occurs. This type of scheduling requires time synchronization with respect to the beat period. More specifically, it requires the knowledge of the beat period P0 and the time offset t0 that can be obtained from sensing data or provided by the network e.g., a base station for trains or for vehicles if they are covered by any.

Each periodic step function may be written as follows:

$${F}_{1} ( t ) = {F}_{1} ( t + k {P}_{1} ) = \{ \begin{matrix}1 , & {kP}_{1} < t < k {P}_{1} + {s}_{1} , k = 0 , 1 , … \\ 0 , & otherwise\end{matrix} , \qquad ( 1 )$$

$${F}_{2} ( t ) = {F}_{2} ( t + k {P}_{2} ) = \{ \begin{matrix}1 , & \begin{matrix}{kP}_{2} < {t}_{0} < t < {kP}_{2} + {t}_{0} + \\ {s}_{2} , k = 0 , 1 , …\end{matrix} \\ 0 , & otherwise\end{matrix} , \qquad ( 2 )$$

where Pᵢ is the period of the corresponding periodic step function Fᵢ(t), sᵢ is a time interval during which the radio frequency resource is used by the corresponding device Di, and t0 is the time offset between F2(t) and F1(t).

In one embodiment, the collision rate for each device and an arbitrary selected time interval T can be estimated as:

Cᵢ(T, t₀)=∫₀^{T}G(t)dt/∫₀^{T}Fᵢ(t)dt, (3)

where i=1,2 for D1 and D2, respectively, and G(t) is an overlap function defined, for instance, as

$$G ( t ) = \{ \begin{matrix}1 , {F}_{1} ( t ) = {F}_{2} ( t ) = 1 \\ 0 , else\end{matrix} \qquad ( 4 )$$

If F1(t) and F2(t) are periodic functions, then the overlap function G(t) is also periodic with a period P0 equal to the least common multiple (LCM) of the periods of F1(t) and F2(t). In one embodiment, it may thus be beneficial to select a time interval T equal to the period of the overlap function P0, namely:

T=P₀=LCM(P₁, P₂), (5)

In one embodiment, the value T=P0 is used to calculate an asymptotic value of the collision rate based solely on the frame lengths P1 and P2.

Thanks to the periodicity of the overlap function, such a definition of T makes the collision rate function Ci invariant with respect to the time offset t0. Moreover, the value of Ci calculated for T=P0, may be considered as an asymptotic value for an arbitrary selected time interval T, provided T is much greater than P0.

On FIG. 4 the opportunity window is characterized by a zero collision rate. In other embodiments, the opportunity window may support any collision rate whose value is between 0 and C₂ where C₂ is a value of the collision rate calculated for time interval T=LCM(P1,P2).

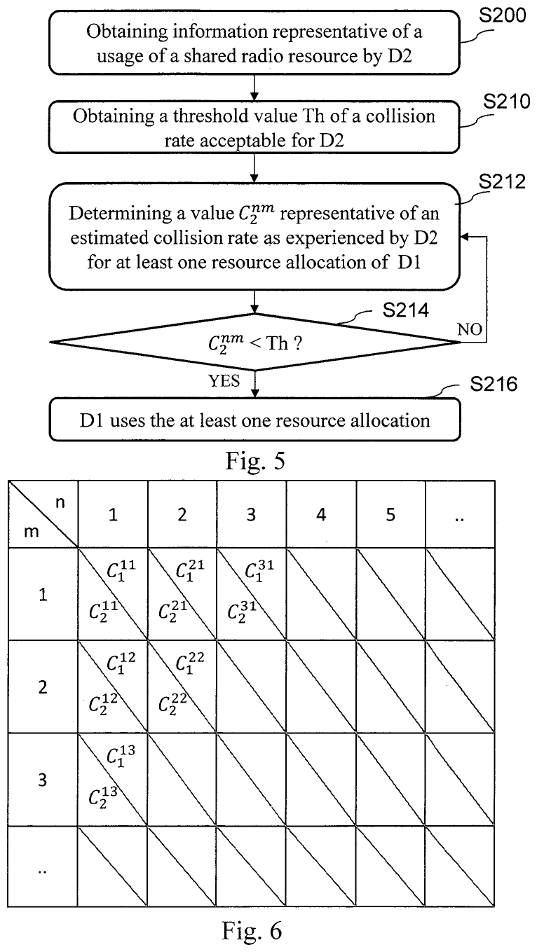

FIG. 5 depicts a flowchart of a method for radio frequency resource allocation according to a first embodiment. More particularly, the method is for allocating a portion of a radio frequency resource to a first device, e.g. the device D1, said radio frequency resource being shared between said first device D1 and at least one second device, e.g. the device D2. The method is disclosed from the point of view of the first device D1 in FIG. 1. The first device D1 may be informed of the existence of D2 by RAN1 through the application layer. In this case, the application layers of D1 and D2 exchange information so as to inform each other of their presence in a given geographical area and of other information (see hereafter). To this aim, MEC devices (acronym of “Multi-access Edge Computing”), e.g. MEC servers may be used. Multi-access edge computing (MEC), formerly mobile edge computing, is an ETSI-defined network architecture concept that enables cloud computing capabilities and an IT service environment at the edge of the cellular network and, more in general at the edge of any network.

At step S200, the first device D1 obtains information representative of a usage of said radio frequency resource by the second device; i.e. the device D2 in FIG. 1.

In one embodiment, the information representative of a usage of said radio frequency resource by the second device D2 comprise a frequency resource allocation pattern (RA pattern) and a time interval (e.g. dT2 or P2) related to the definition of the collision rate. The information representative of a usage of the radio frequency resource by the second device D2 may be obtained by the first device D1 directly from the second device D2 through application or physical layers, by sensing or from preconfigured data defined, e.g. in factory, for example in a standard document. In one embodiment (related to a distributed use case), these preconfigured data may be extracted from the corresponding standards associated with D2 and stored in a memory of D1. Alternatively, it can be stored on a MEC device accessible through RAN1.

At step S210, the first device D1 obtains one threshold value Th of a collision rate acceptable for the second device D2. Said otherwise, if a collision rate is below the threshold value Th, it is considered as an acceptable collision rate while if it is above, it is considered as a non-acceptable collision rate. A threshold value Th is thus associated with an acceptable collision rate and is attributed to each device according to its minimum requirements in terms of interference level, e.g. SIR, to ensure a sufficient proportion of correct received packets that is determined by its own radio configuration such as its modulation and coding scheme, its waveform, its frequency allocation, etc. The threshold value Th may be obtained by the first device D1 directly from the second device D2 through their application layers. In a variant, when the devices D1 and D2 use identical radio access technology, the threshold value Th may be obtained by the first device D1 from the second device D2 through their physical layers. Indeed, in this latter case, D1 and D2 may exchange preliminary data to agree on their thresholds for the next data to come because they have common specifications at the physical layer. In another variant, the threshold value Th may be obtained by the first device D1 from the network e.g., a base station for trains or for vehicles if they are covered by any . In yet another variant, the threshold value Th may be obtained by the first device D1 from preconfigured data defined, e.g. in factory, for example in a standard document. In one embodiment (related to a distributed use case), these preconfigured data may be extracted from the corresponding standards associated with D2 and stored in a memory of D1. Alternatively, it can be stored on a MEC device accessible through RAN1.

At step S212, the first device D1 determines a value C₂^{nm} representative of an estimated collision rate as experienced by the second device D2 for at least one frequency resource allocation RA₁ of the first device D1, where n and m identify the frequency resource allocation of D1 and D2 respectively. The value C₂^{nm} is determined notably from the obtained information representative of the usage of the radio frequency resource by the second device D2. The at least one frequency resource allocation RA1 of the first device may be one frequency resource allocation selected in a list of predefined frequency resource allocations. In an embodiment, the frequency resource allocation RA1 is defined by a RA pattern such as the deterministic pattern associated with a periodic traffic comprising a sequence of identical frames as depicted in FIG. 2. The estimated collision rate C₂^{nm} may thus be determined by mapping both functions F1(t) and F2(t) in order to obtain the overlaps in RR usage as illustrated in FIG. 3 or FIG. 4. In a variant, the frequency resource allocation RA1 is a random one.

At step S214, the value C₂^{nm} is compared to the threshold value Th. In the case where C₂^{nm}<Th, the method continues at step S216. Otherwise the method continues at step S212. Another frequency resource allocation, different from RA₁, e.g. a different pattern, may thus be tested for the first device D1.

In a variant, the first device D1 determines a value C₂^{nm} representative of an estimated collision rate from a database of preconfigured RA patterns as depicted in FIG. 6. In case of a time sensitive network (TSN), the database may preferably be stored in the device D1 or in a MEC device. Alternatively, for non-TSN, it can be stored in the cloud. In FIG. 6, the database provides the estimated collision rate C₁^{nm} as experienced by D1 for a selected combination of two RA patterns identified by indices n and m. Thus, n identifies a RA pattern in a list of pre-selected RA patterns of D1 and m identifies a RA pattern in a list of pre-selected RA patterns of D2.

The database also provides the estimated collision rate C₂^{nm} as experienced by D2 for a selected combination of two RA patterns identified by indices n and m. Such a database can be provided to at least one of the devices, e.g. the first device D1, to facilitate its frequency resource allocation. Indeed, using the database may reduce the computation time for determining a RA pattern satisfying a given threshold value Th. Indeed, the first device D1 may directly select an appropriate RA pattern from the database that satisfies the threshold value Th.

At step S216, the frequency resource allocation RA₁ is used for the first device D1.

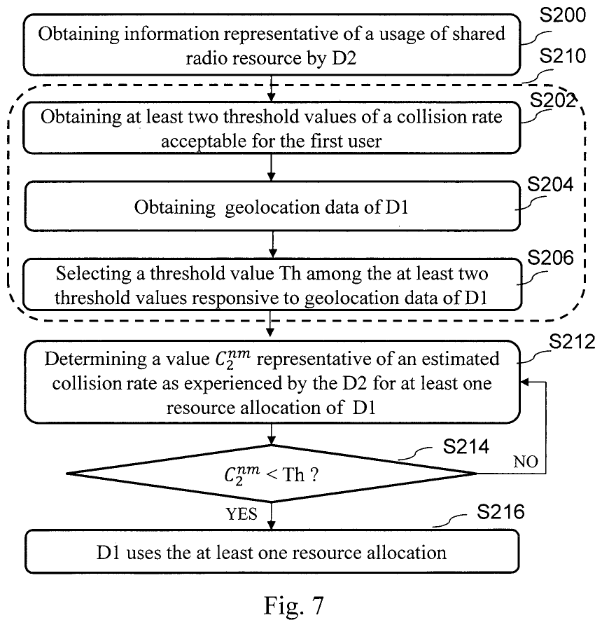

FIG. 7 depicts a flowchart of a method for radio frequency resource allocation according to a second embodiment. The steps identical to the step of FIG. 2 are identified by the same numeral references and are not further disclosed.

The method according to this second embodiment comprises the steps S200 to S216. In this second embodiment, the step S210 comprises several steps as depicted in FIG. 7.

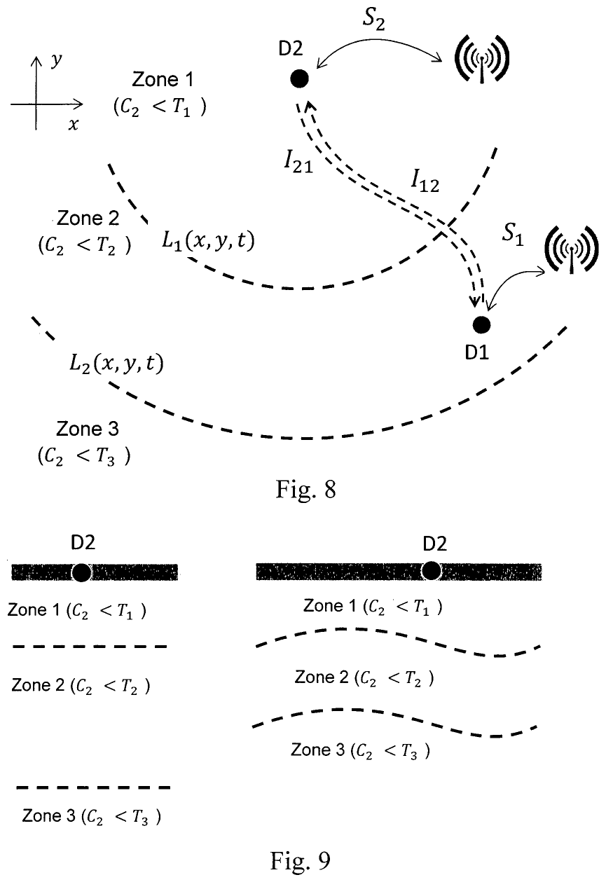

In a step S202, the first device D1 obtains at least two threshold values of a collision rate acceptable for the second device D2, each of the at least two threshold values being associated with a specific spatial zone as illustrated by FIG. 8. On FIG. 8, C2 is the estimated collision rate as experienced by D2. On FIG. 8 there is no reference to specific a selected combination of two RA patterns identified by indices n and m that is why C₂ is used instead of C₂^{nm}. This embodiment is particularly well-suited in the case where the device D2 is in a train and the device D1 is in a vehicle, e.g. a car. In this case, the train (acting as D2) may predict the interference signal level from a vehicle (i.e. 112) for a worst scenario (i.e. vehicle speed, position, moving direction, antenna pattern, maximum allowed transmitted power, and propagation channel conditions) and thus define spatial zone(s) associated with different threshold values of acceptable collision rates. The threshold values and associated spatial zones may be obtained by the first device D1 directly from the second device D2, from pre-configuration data or from the network, etc (as already explained above). Said information on the threshold values can be provided by D2 in real time, e.g. by broadcasting through a physical media or through an application layer, or in advance, e.g. in a form of a time schedule linked with a geolocation map. In FIG. 8, three spatial zones are defined around the device D2. Li(x,y,t) is the outline of the i-th spatial zone associated with a threshold value denoted as Ti, (x,y) are the coordinates in a coordinate system, t is time. In FIG. 8, the spatial zones are defined by circles around D2. It will be appreciated, however, that the present embodiments are not restricted to this specific definition of the spatial zones which may have different forms as depicted in FIG. 9. In an exemplary embodiment, the threshold values may be associated with spatial zones, defined with respect to elements of an infrastructure (e.g. railway lines and automotive roads). Therefore, the first device D1 may obtain the three threshold values of a collision rate acceptable for the second device D2, each threshold being associated with a specific spatial zone.

In a step S204, the first device D1 obtains information representative of its own geolocation or information making it possible to determine its relative distance to D2. The obtained information is used for determining to which spatial zone the first device D1 belongs. In a variant wherein several overlapping spatial zones are defined, the first device D1 may also obtain geolocation data of the second device D2 to select an appropriate threshold value. In a step S206, the first device D1 selects one threshold value Th among the at least two threshold values obtained responsive to the information obtained at the step S204. With respect to FIG. 8, the first device D1 belongs to spatial zone 2 and thus selects the threshold value T2 among T1, T2 and T3. In a variant, the first device D1 determines its distance from the second device D2 from information obtained at the step S204 and selects the threshold values responsive to this distance.

The distance may be calculated directly, based on geolocation data, or estimated by sensing. The signal level may be used to estimate the relative position and/or distance between the devices, using some additional information associated with the communication and obtained at the step S204 (e.g. about the propagation channel and direction of the interference signal arrival). In a first approximation, a classical link budget estimation based on the Friis formula may be used to calculate the attenuation of the signal level between two devices at a given distance R. It can be applied by D1 to estimate a distance to D2 based on the received signal (I21). Indeed, the Friis formula is defined as follows:

$${P}_{r} = α {P}_{t} {D}_{t} {{D}_{r} ( \frac{λ}{4 π R} )}^{2}$$

where Dt and Dr are the antenna directivities along the line of sight (with respect to an isotropic radiator) of the transmitting (D2) and receiving (D1) antennas, respectively, λ is the wavelength, R is the distance between the antennas, parameter a takes into account the factors affecting the radio channel properties, such as attenuation in the medium, antenna alignment, polarization, multipath, etc. Here, we further assume that R>>λ, such that both antennas are in the far field of each other, and the bandwidth is narrow enough that a single value for the wavelength λ can be assumed. This formula thus makes it possible to calculate the power that is received by one antenna from another when transmitted from a distance R, and consequently the distance R can be estimated from received power in a reverse manner.

This embodiment based on the spatial zones works in the cases where the second device D2 is present and is not present. Indeed, the first device D1 may take a decision about frequency resource allocation to anticipate a future arrival of D2, e.g. defined by a time schedule or obtained from the network. For instance, a vehicle (acting as device D1) may thus anticipate a future need of a train (acting as device D2) for RR at the time of its arrival.

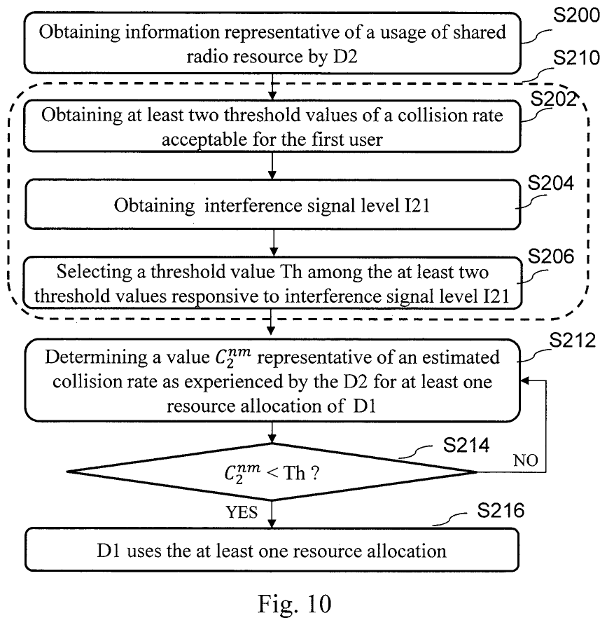

FIG. 10 depicts a flowchart of a method for radio frequency resource allocation according to a third embodiment. The steps identical to the step of FIG. 2 are identified by the same numeral references and are not further disclosed.

The method according to this third embodiment comprises the steps S200 to S216. In this third embodiment, the step S210 comprises several steps as depicted in FIG. 10.

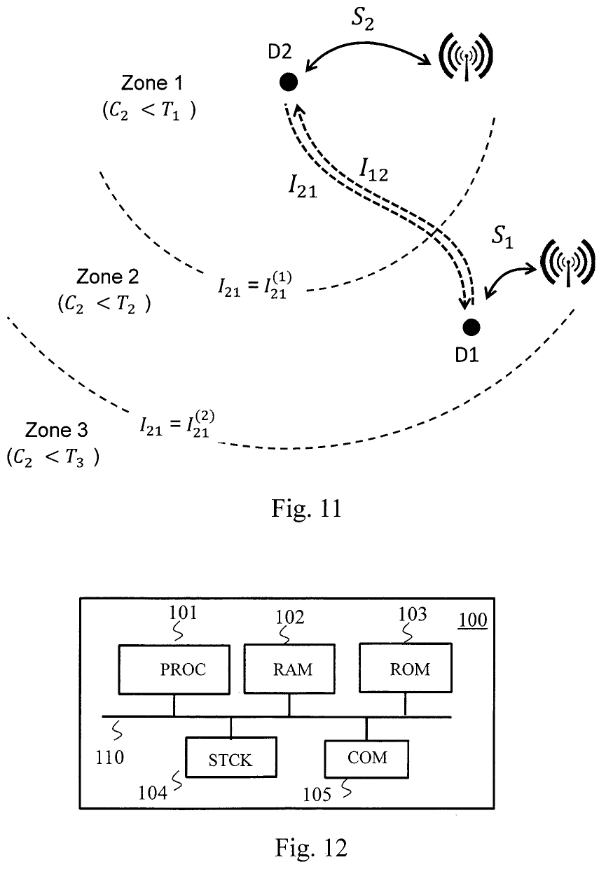

In a step S202, the first device D1 obtains at least two threshold values of a collision rate acceptable for the second device D2, each of the at least two threshold values being associated with a specific level of interference signal as illustrated in FIG. 11. The threshold values and associated level of interference zones may be obtained by the first device D1 from the second device D2, from pre-configuration data or from the network, etc (as already explained above). The information can be provided by D2 in real time, e.g. by broadcasting through a physical media or through the application layer. This embodiment based on the interference signal level requires the second device D2 to be effectively present.

The threshold values may be defined as a function of the interference signal levels as sensed by the first device D1 (i.e. I21). In this embodiment, the threshold values for D2 may be defined as follows:

If I21_min(j)<I21<I21_max(j), then Threshold value is equal to T(j), where j is a number identifying a range of interference signal level.

The values of I21_min(j) and I21_max(j) are defined by D2 taking into account the worst scenario for the propagation channel conditions and D1 physical layer (i.e. directivity, pattern, max transmitted power, etc.). Indeed, when defining the thresholds D2 has limited or no information about D1 and thus has to consider a worst case (i.e. a case leading to a maximum level of interference signal).

In this embodiment, the first device D1 does not require to know its position nor its distance to D2. This information is already included in the definition of threshold values through the values of I21_min(j) and I21_max(j) defined by D2. Because of the reciprocity, the propagation channel conditions are the same in both directions. This makes it possible for D2 to predict a possible level of interference signal from D1 (i.e. I12) and to define threshold values accordingly.

In the step S204, the first device D1 obtains the level of interference signal I₂₁. In one embodiment, the level of interference signal I₂₁ is obtained by measurements possibly using some signal processing.

In the step S206, the first device D1 selects one threshold value Th among the at least two threshold values obtained at the step S202 responsive to the information obtained at the step S204.

The methods described above may comprise a feedback from the second device D2 to the first device D1 and/or to other devices using the same RR.

In one embodiment, the feedback mechanism can be used by D2 to notify D1 about the actual impact experienced by D2 due to D1. This makes it possible for D1 to adapt its use of the shared radio frequency resource accordingly. The feedback information provided by D2 to D1 may comprise new threshold values and/or new time interval dT2. Thus in one particular embodiment, the first device D1 receives new threshold values, said new threshold values being determined from the actual collision rate experienced by the second device because of the first device.

In another embodiment, the feedback mechanism can be used to anticipate a multi-device scenario. In particular, it may allow D2 to adapt its threshold value(s) in the case where the same RR is used by more than 2 devices. In one embodiment, a 3rd device D3 uses the same RR as D1 and D2. The threshold value(s) Th associated with D2 may be determined in order to guarantee that the cumulative impact of D1 and D3 on D2 (i.e. I12+I32) meets the minimum requirements of D2.

The above methods may be used with devices D1 and D2 having an equal-right use of RR or with a device D1 (respectively D2) being a primary device and the device D2 (respectively D1) being a secondary device. In an extreme case, the threshold value(s) associated with the primary device may tend to a value corresponding to a case where the primary device is allowed to select any RA, regardless to the collision rate experienced by the secondary device. For example, to give advantage in RR use for a primary device, its threshold value for the collision rate may be set equal zero. After obtaining such a threshold value, the secondary device is obliged either to determine a RA that guarantees a collision-free use of the same RR or to avoid using this RR.

FIG. 12 illustrates schematically an example of hardware architecture of the first device D1.

According to the example of hardware architecture shown in FIG. 10, the device D1 comprises, connected by a communication bus 110: a processor or CPU (acronym of “Central Processing Unit”) 101; a random access memory RAM 102; a read only memory ROM 103; a storage unit or a storage medium reader such as an SD (acronym of “Secure Digital”) card reader 104 or a HDD (acronym of “Hard Disk Drive”); and at least one set of communication interfaces COM 105 enabling the device D1 to transmit and receive data.

The processor 101 is capable of executing instructions loaded into the RAM 102 from the ROM 103, from an external memory (such as an SD card), from a storage medium (such as the HDD), or from a communication network (such as RANI or another communication network). When the device D1 is powered up, the processor 101 is capable of reading instructions from the RAM 102 and executing them. These instructions form a computer program causing the implementation, by the processor 101, of the method described in relation to FIG. 5 or 7.

The methods described in relation to FIGS. 5 and 7 may be implemented in software form by the execution of the set of instructions by a programmable machine, for example a DSP (acronym of “Digital Signal Processor”), a microcontroller or a GPU (acronym of “Graphics Processing Unit”), or be implemented in hardware form by a machine or a dedicated component (chip or chipset), for example an FPGA (acronym of “Field-Programmable Gate Array”) or an ASIC (acronym of “Application-Specific Integrated Circuit”). In general, the device Dl (identically for device D2) includes electronic circuitry adapted and configured for implementing the methods described in relation to FIGS. 5 and 7.

1. A method for allocating a radio frequency resource to a first device connected to a first radio access network, said radio frequency resource being shared between said first device and at least one second device connected to a second radio access network, characterized in that the method comprises the following steps executed by the first device:
obtaining information representative of a usage of said radio frequency resource by said second device;
obtaining a threshold value of a collision rate acceptable for the second device;
determining a value representative of an estimated collision rate as experienced by the second device for at least one frequency resource allocation of the first device from the obtained information representative of the usage of said radio frequency resource by said second device;
using said at least one frequency resource allocation for the first device in the case where the determined value is below the obtained threshold value.

2. The method of claim 1, wherein said information representative of a usage of said radio frequency resource by said second device comprises a frequency resource allocation pattern and a value of a time interval related to collision rate estimation.

3. The method of claim 2, wherein determining a value representative of an estimated collision rate as experienced by the second device for at least one frequency resource allocation of the first device being defined by another frequency resource allocation pattern comprises mapping said frequency resource allocation pattern and said another frequency resource allocation pattern in order to obtain overlaps in frequency resource allocation during a time interval and determining the value by dividing the obtained overlaps by the overall time of usage of said radio frequency resource by said second device during said time interval, wherein said time interval is defined from said time interval related to collision rate estimation.

4. The method according to claim 1, wherein said information representative of a usage of said radio frequency resource by said second device is obtained by the first device from said second device through application layer or physical layer, by sensing or from preconfigured data.

5. The method of claim 1, wherein determining a value representative of an estimated collision rate as experienced by the second device for at least one frequency resource allocation to the first device is determined from a database of preconfigured frequency resource allocation pattern, wherein said database associates with each possible combination of frequency resource allocation patterns an estimated collision rate for the first device and an estimated collision rate for the second device.

6. The method according to claim 1, wherein obtaining a threshold value of a collision rate acceptable for the second device comprises:
obtaining at least a first threshold value and a second threshold value of a collision rate acceptable for the second device, said first and second threshold values each being associated with a spatial zone or a level of interference signal; and
selecting said one threshold value among said first and second threshold values.

7. The method of claim 6, wherein selecting said one threshold value among said first and second threshold values comprises:
determining a location of said first device; and
selecting the threshold value responsive to said location.

8. The method of claim 6, wherein selecting said one threshold value among said first and second threshold values comprises:
determining a distance between said first device and said second device; and
selecting the threshold value responsive to said distance.

9. The method of claim 6, wherein selecting said one threshold value among said first and second threshold values:
determining a level of interference signal as sensed by the first device; and
selecting the threshold value responsive to said level of interference signal.

10. The method according to claim 6, wherein said at least a first threshold value and a second threshold value of an acceptable collision rate for the second device are obtained by said first device from the network, from said second device through application or physical layer or from preconfigured data.

11. The method according to claim 1, further comprising receiving new threshold values of a collision rate acceptable for the second device, said new threshold values being determined from the actual collision rate experienced by the second device because of the first device.

12. The method according to claim 1, further comprising receiving new threshold values of a collision rate acceptable for the second device, said new threshold values being determined from the actual collision rate experienced by the second device because of the first device and at least a third device.

13. The method according to claim 1, wherein the first and the second radio access networks implement different radio access technologies.

14. A device connected to a first radio access network, said device sharing a radio frequency resource with at least one second device connected to a second radio access network, characterized in that the device comprises:
means for obtaining information representative of a usage of said radio frequency resource by said second device;
means for obtaining a threshold value of a collision rate acceptable for the second device;
means for determining a value representative of an estimated collision rate as experienced by the second device for at least one frequency resource allocation of the first device from the obtained information representative of the usage of said radio frequency resource by said second device;
means for using said at least one frequency resource allocation for the first device in the case where the determined value is below the obtained threshold value.

15. A computer program product comprising program code instructions that can be loaded in a programmable device, the program code instructions causing implementation of the method according to claim 1 when the program code instructions are run by the programmable device.

16. A non-transitory information storage medium storing a computer program comprising program code instructions, the program code instructions causing implementation of the method according to claim 1 when the program code instructions are read from the non-transitory information storage medium and run by the programmable device.
